(19) United States
(12) Patent Application Publication
(10) Pub. No.: US 2015/0239105 A1
(43) Pub. Date: Aug. 27, 2015

(54) RATCHET WRENCH WITH REPLACEABLE TOOL HEAD

(71) Applicant: Chia-Yu CHEN, Taichung (TW)

(72) Inventor: Chia-Yu CHEN, Taichung (TW)

(21) Appl. No.: 14/190,530

(22) Filed: Feb. 26, 2014

(51) Int. Cl. B25B 13/46; F16D 41/16; B25B 23/00

(52) U.S. Cl. CPC B25B 13/463; B25B 23/0035; F16D 41/16

(57) ABSTRACT

A ratchet wrench with a replaceable tool head includes a wrench main body. The wrench main body has an accommodation trough and a first through hole. The tool head is accommodated in the accommodation trough. The tool head has an annular groove. A switch block is provided at one side of the tool head. Two detents are respectively provided at two sides of the switch block. The detents each have an engaging block corresponding to the annular groove. The switch block can control the engaging blocks of the detents to be engaged in the annular groove. When the engaging blocks are not in the annular groove, the tool head can be taken out from the accommodation trough for replacement. The tool head of the present invention is replaceable, the manufacture cost is low, and the structure of the present invention is simple.

### BACKGROUND OF THE INVENTION

1. Field of the Invention The present invention relates to a ratchet wrench, and more particularly to a ratchet wrench having a replaceable tool head and having a bi-directional control.

2. Description of the Prior Art

A replaceable structure of a ratchet wrench is a hand tool for the user to lock or unlock a bolt and a nut, and its ratchet can be replaced as desired. A conventional replaceable structure of a ratchet wrench, as disclosed in U.S. Patent No. 8042433, comprises a head portion. The head portion has a hollow trough to accommodate a ratchet. The inner wall of the hollow trough is transversely formed with an accommodation trough. The wrench main body has an accommodation hole which is in communication with the accommodation trough. The accommodation hole is provided with a pawl member. The pawl member is provided with an elastic pin. The pawl member is connected with a switch. The accommodation trough is further provided with a fixing seat and a lid. The fixing seat is adapted to fix the elastic pin. The pawl member is provided with a limit protrusion. The ratchet has an annular limit groove corresponding to the limit protrusion. The limit protrusion is received in the limit groove to limit the ratchet. When the switch is switched by the user for the limit protrusion to be moved inward to disengage from the limit groove, the ratchet can be taken out from the hollow trough for the user to replace with a desired ratchet. However, the conventional replaceable structure of the ratchet wrench needs to provide the fixing seat and the lid. The lid is formed with a push notch and a release notch corresponding to the switch for the switch to be switched. The conventional replaceable structure of the ratchet wrench is complex and difficult to be manufactured. The assembly procedure is complicated and the manufacture cost is high. Accordingly, the inventor of the present invention has devoted himself based on his many years of practical experiences to solve these problems.

### SUMMARY OF THE INVENTION

The primary object of the present invention is to provide a ratchet wrench with a replaceable tool head. It is convenient for the user to replace with a desired tool head. The structure of the ratchet wrench is simple and can be assembled and manufactured with ease. The manufacture cost of the ratchet wrench is low.

In order to achieve the aforesaid object, the ratchet wrench with a replaceable tool head of the present invention comprises a wrench main body. The wrench main body has an accommodation trough at a front end thereof and a first through hole at a bottom of the accommodation trough. The tool head is accommodated in the accommodation trough. The outer circumferential wall of the tool head is formed with ratchet teeth. The tool head has an annular groove. Two detents are provided in the accommodation trough. The detents each have ratchet teeth at a front end thereof to mesh with the tool head. The detents each have an engaging block. The engaging block can be engaged in the annular groove. A switch block is provided in the accommodation trough and located between the two detents. A spring is provided between each of the detents and a side wall of the accommodation trough, such that each of the detents is biased by the spring.

Thereby, the switch block can be switched by the user to press one of the detents to mesh with the ratchet teeth of the tool head and to bring the engaging block of the elected detent to be engaged in the annular groove for the user to use the tool head of the wrench main body. When the two sides of the switch block are respectively against the detents, the engaging blocks of the detents are not in the annular groove, such that the tool head can be taken out from the accommodation trough for replacement. The ratchet wrench with the replaceable tool head of the present invention uses the relationship that the engaging blocks of the detents can be engaged in the annular grove and the relationship that the switch block and the detents can be engaged with each other for the user to operate and change the tool head. The structure of the ratchet wrench of the present invention is simple and can be assembled and manufactured with ease. The manufacture cost of the ratchet wrench is low.

### BRIEF DESCRIPTION OF THE DRAWINGS

FIG. 1 is a perspective view according to a preferred embodiment of the present invention;

FIG. 2 is an exploded view according to the preferred embodiment of the present invention;

FIG. 3 is a transverse sectional view according to the preferred embodiment of the present invention, showing that the engaging blocks are not in the annular groove;

FIG. 4 is a schematic view according to the preferred embodiment of the present invention in use, showing that the tool head disengages from the wrench main body;

FIG. 5 is a transverse sectional view according to the preferred embodiment of the present invention, showing that the switch block is against the right detent;

FIG. 6 is a transverse sectional view according to the preferred embodiment of the present invention, showing that the switch block is against the left detent;

FIG. 7 is a vertical sectional view according to the preferred embodiment of the present invention, showing that the engaging blocks are in the annular groove; and

FIG. 8 is a vertical sectional view according to another embodiment of the present invention.

### DETAILED DESCRIPTION OF THE PREFERRED EMBODIMENTS

Embodiments of the present invention will now be described, by way of example only, with reference to the accompanying drawings.

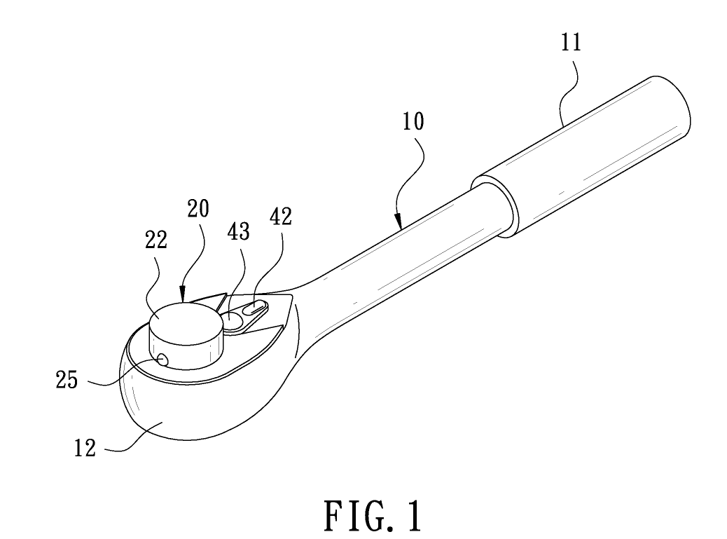

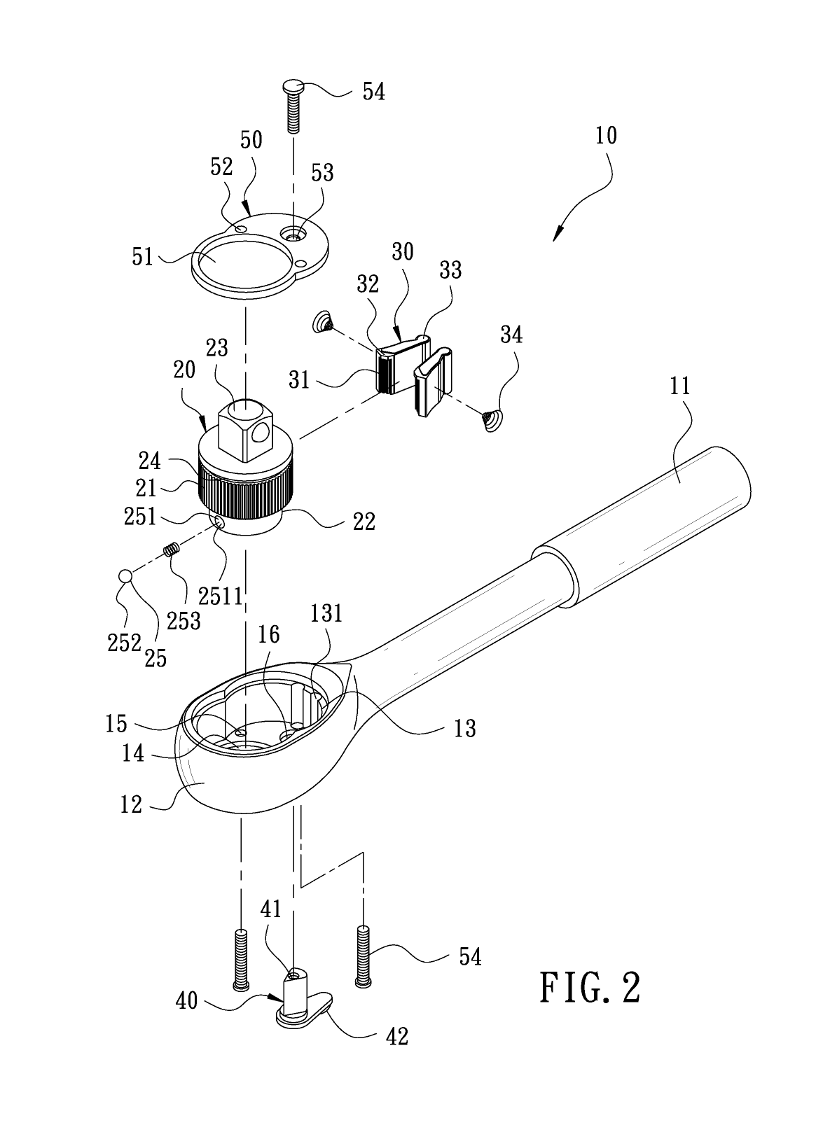

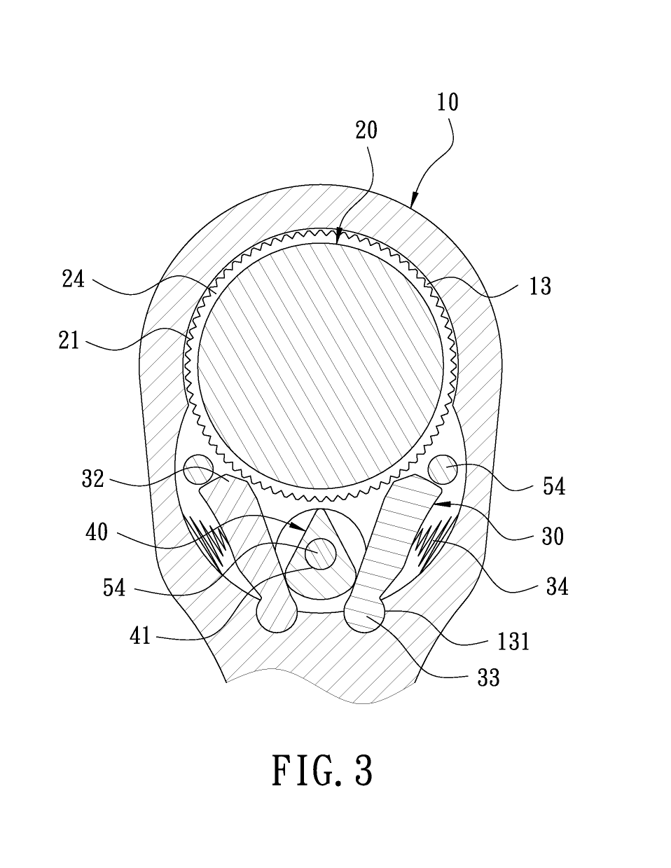

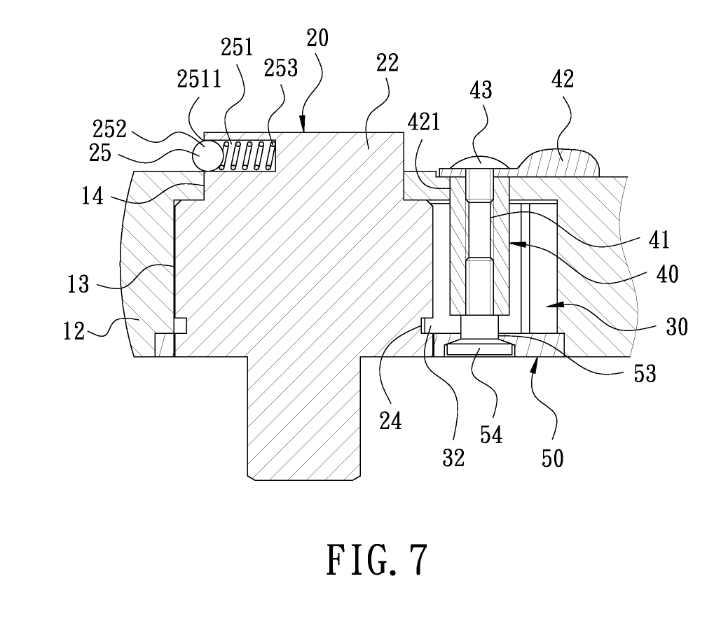

FIG. 1 is a perspective view according to a preferred embodiment of the present invention. FIG. 2 is an exploded view according to the preferred embodiment of the present invention. FIG. 3 is a transverse sectional view according to the preferred embodiment of the present invention. FIG. 7 is a vertical sectional view according to the preferred embodiment of the present invention. The present invention discloses a ratchet wrench with a replaceable tool head. The ratchet wrench comprises a wrench main body 10, a tool head 20, two detents 30, a switch block 40, and a lid 50.

The wrench main body 10 has a handle 11. One end of the handle 11 is formed with a head portion 12. One side of the head portion 12 has an accommodation trough 13, and another side of the head portion 12 has a first through hole 14 which is in communication with the accommodation trough 13 and two vertical through apertures 15 close to the first through hole 14. The top of the wrench main body 10 has an axle hole 16. The inner wall of the accommodation trough 13 is formed with two curve grooves 131 which are arranged vertically.

The tool head 20 has a cylindrical shape. The tool head 20 is disposed in the accommodation trough 13. The outer circumferential wall of the tool head 20 is formed with ratchet teeth 21. The upper end of the tool head 20 is provided with a protruding post 22, and the lower end of the tool head 20 is provided with an engaging portion 23. The protruding post 22 is inserted in the first through hole 14. The tool head 20 has annular groove 24 disposed under the ratchet teeth 21. The outer circumferential wall of the protruding post 22 is provided with a first positioning member 25. The outer circumferential wall of the protruding post 22 is transversely formed with a circular recess 251 with an opening 2511. The first positioning member 25 is accommodated in the circular recess 251. The first positioning member 25 comprises a steel ball 252 and a spring 253. The spring 253 is transversely disposed in the circular recess 251. The steel ball 252 is disposed at the front end of the spring 253. The diameter of the opening 2511 is less than that of the steel ball 252, so the steel ball 252 won't fall out of the opening 2511. The steel ball 252 is biased by the spring 253 and a portion of steel ball 252 protrudes out of the circular recess 251.

Each of the two detents 30 has ratchet teeth 31 at a front end thereof, an engaging block 32 transversely disposed under the ratchet teeth 31, and a pivot portion 33 at a rear end thereof. The pivot portions 33 of the two detents 30 are received in the curve grooves 131, such that the two detents 30 can pivot in the curve grooves 131. The engaging block 32 can be engaged in the annular groove 24 of the tool head 20. A spring 34 is provided between one side of each detent 30 and the inner wall of the accommodation trough 13. The spring 34 enables each detent 30 to have a return force.

The switch block 40 is vertically inserted to the axle hole 16 of the wrench main body 10 and located between the two detents 30. The switch block 40 has a vertical threaded hole 41 therein and a lever 42. The lever 42 has a through hole 421 corresponding to the threaded hole 41. The lever 42 is coupled to the top of the wrench main body 10 with a fixing member 43 screwed to the threaded hole 41 and the through hole 421, such that the fixing member 43, the lever 42 and the switch block 40 are assembled together. Thereby, the lever 42 is operated to turn the switch block 40 left or right so as to press one of the detents 30. When the switch block 40 presses one of the detents 30, the engaging block 32 of the detent 30 is engaged in the annular groove 24 of the tool head 20, and the ratchet teeth 31 of the detent 30 mesh with the ratchet teeth 21 of the tool head 20. The switch block 40 can control the turning direction of the tool head 20.

The lid 50 is adapted to cover the accommodation trough 13 of the wrench main body 10. The lid 50 has a second through hole 51. The tool head 20 is inserted in the second through hole 51 and can be pivoted in the second through hole 51. The lid 50 has threaded holes 52 corresponding to the through apertures 15 of the wrench main body 10 and a through hole 53 corresponding to the threaded hole 41 of the switch block 40. In this embodiment, screws 54 are screwed to the through apertures 15 of the wrench main body 10 and the threaded holes 52 of the lid 50, and another screw 54 is screwed to the through hole 53 of the lid 50 and the threaded hole 41 of the switch block 40, such that the lid 50 and the wrench main body 10 are assembled together.

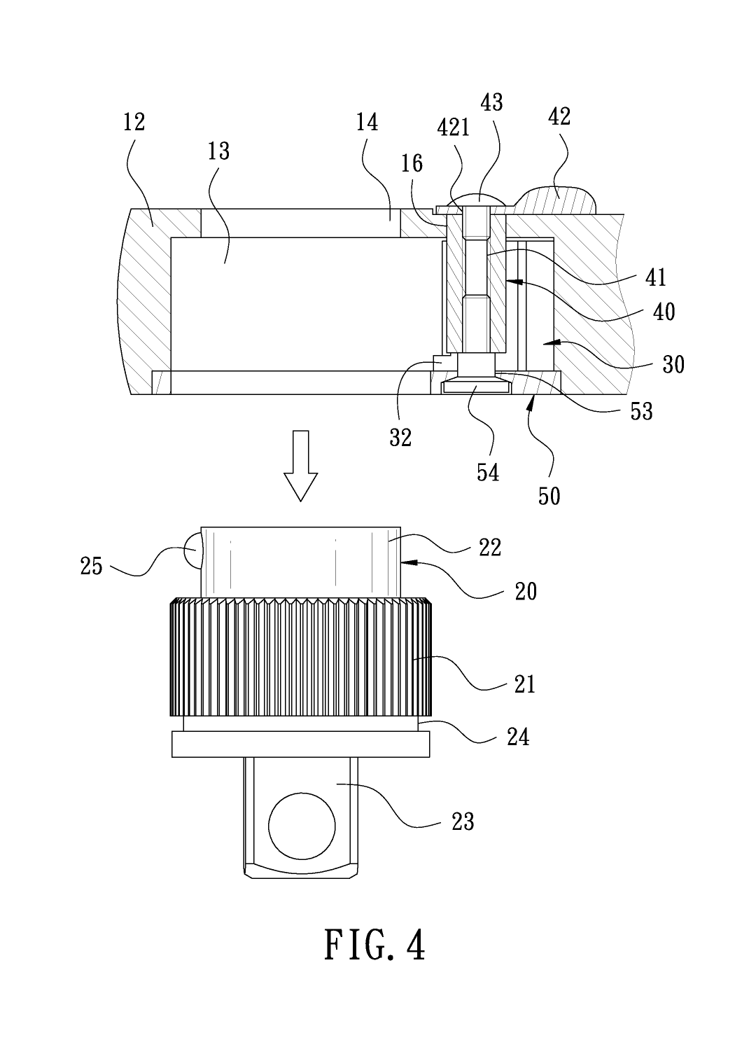

FIG. 1 is a perspective view according to the preferred embodiment of the present invention. FIG. 3 is a transverse sectional view according to the preferred embodiment of the present invention. FIG. 4 is a schematic view according to the preferred embodiment of the present invention in use, showing that the tool head disengages from the wrench main body. In the drawings, when the switch block 40 is switched to the middle position by the user, the lever 42 drives two sides of the switch block 40 to lean against the two detents 30 respectively, such that the detents 30 don't mesh with the tool head 20 and the engaging blocks 32 of the detents 30 are not in the annular groove 24 to become a separate state. Thus, the tool head 20 can be taken out from the accommodation trough 13 for replacement.

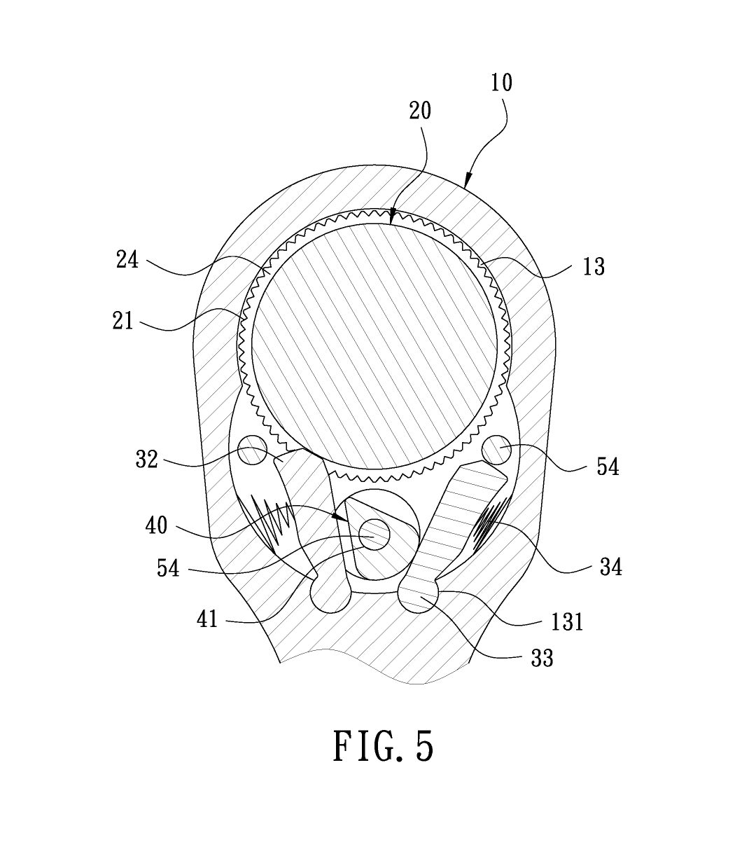

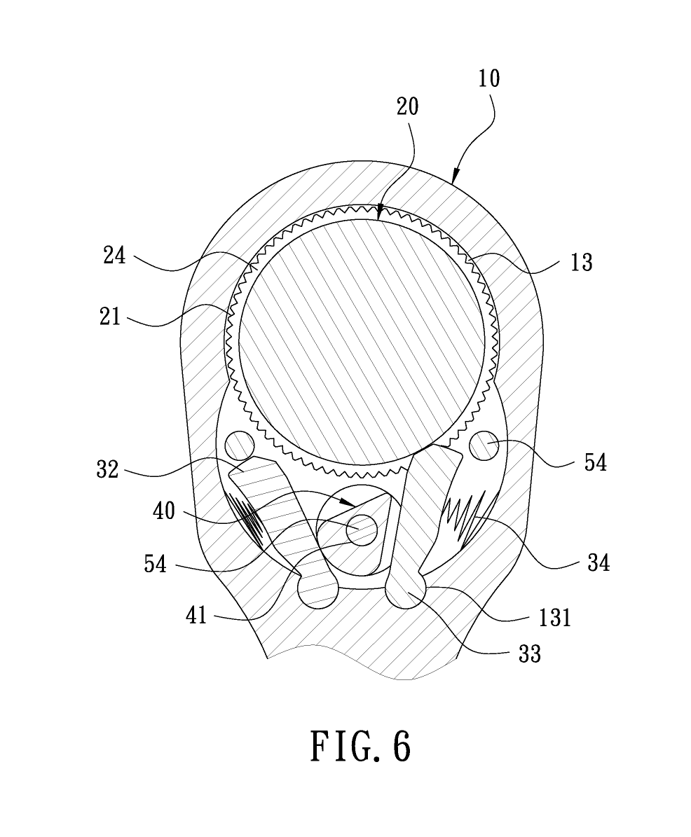

FIG. 1 is a perspective view according to the preferred embodiment of the present invention. FIG. 5 is a transverse sectional view according to the preferred embodiment of the present invention, showing that the switch block is against the right detent. FIG. 6 is a transverse sectional view according to the preferred embodiment of the present invention, showing that the switch block is against the left detent. FIG. 7 is a vertical sectional view according to the preferred embodiment of the present invention, showing that the engaging blocks are in the annular groove. In the drawings, when the switch block 40 is switched to the left or the right by the user, through the fixing member 43, the lever 42 drives the switch block 40 to turn and to press one of the detents 30. The ratchet teeth 31 at the front end of the detent 30 mesh with the ratchet teeth 21 of the tool head 20, and the engaging block 32 of the detent 30 is engaged in the annular groove 24, such that the tool head 20 is unidirectional to be turned and the other side of the tool head 20 is idle.

When the tool head 20 is placed in the accommodation trough 13, the first positioning member 25 at one side of the protruding post 22 is adapted to position the tool head 20 in the accommodation trough 13. The steel ball 252 is biased by the spring 253 for a portion of the steel ball 252 to extend out so as to position the tool head 20. As shown in FIG. 7, when the detents 30 don't mesh with the tool head 20 and the engaging blocks 32 are not engaged in the annular groove 24, the tool head 20 won't disengage from the accommodation trough 13. Thereby, the first positioning member 25 provides a positioning function and can prevent the tool head 20 from disengaging from the accommodation trough 13.

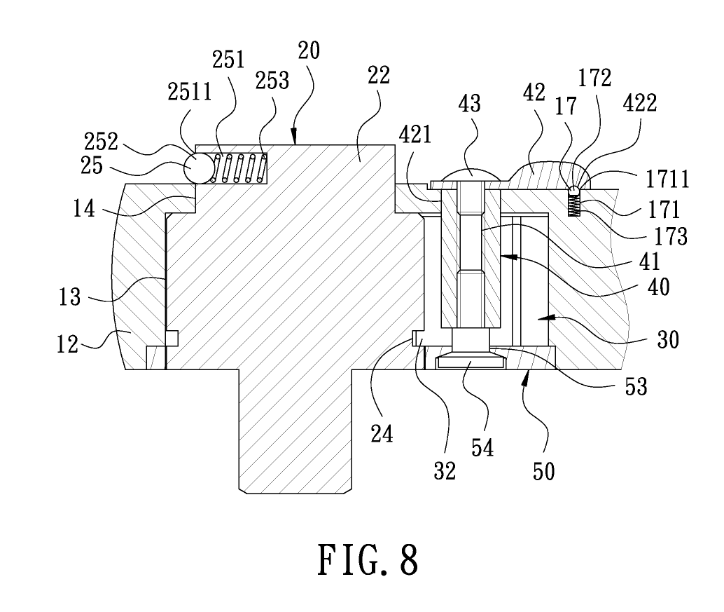

FIG. 8 is a vertical sectional view according to another embodiment of the present invention. In the drawing, the switch block 40 is switched to the middle position. The lower surface of the lever 42 is formed with a recess 422. The wrench main body 10 is provided with a second positioning member 17 corresponding to the recess 422. The second positioning member 17 has a circular recess 171, a steel ball 172, and a spring 173. The circular recess 171 is transversely disposed at the center of the top of the wrench main body 10 and formed with an opening 1711. The spring 173 is vertically disposed in the circular recess 171 and corresponds to the opening 1711. The steel ball 172 is disposed at the upper end of the spring 173. The diameter of the opening 1711 of the circular recess 171 is less than that of the steel ball 172, so the steel ball 172 won't fall out of the opening 1711. The steel ball 172 is biased by the spring 173 and a portion of the steel ball 172 protrudes out of the circular recess 171. When the switch block 40 is switched to the middle position by the user, the recess 422 of the lever 42 engages with the steel ball 172 of the second positioning member 17 to position the lever 42. Due to the link relationship between the switch block 40 and the lever 42, the switch block 40 can be turned right or left to press the detents 30, so that the detents 30 do not mesh with the tool head 20. As shown in FIG. 3, the tool head 20 can be taken out from the accommodation trough 13. Thereby, through the second positioning member 17 and the recess 422 of the lever 42, the lever 42 can be moved to a precise position for the user to change the tool head 20 smoothly.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A ratchet wrench with a replaceable tool head, comprising a wrench main body, the wrench main body having an accommodation trough at a front end thereof and a first through hole at a bottom of the accommodation trough, the tool head being accommodated in the accommodation trough, an outer circumferential wall of the tool head being formed with ratchet teeth, the accommodation trough being provided with a switch block at one side of the tool head, two detents being respectively provided at two sides of the switch block, the detents each having ratchet teeth at a front end thereof to mesh with the tool head, a spring being provided between each of the detents and a side wall of the accommodation trough, and characterized in that:
an upper end of the tool head is provided with a protruding post, a lower end of the tool head is provided with an engaging portion, the tool head has an annular groove disposed between the protruding post and the engaging portion;
the detents each have a transverse engaging block corresponding to the annular groove of the tool head, the engaging block can be engaged in the annular groove;
thereby, the switch block can be switched for electing one of the detents to mesh with the ratchet teeth of the tool head and to bring the engaging block of the elected detent to be engaged in the annular groove, when the two sides of the switch block are respectively against the detents, the engaging blocks of the detents are not in the annular groove, so that the tool head in the accommodation trough can be taken out for replacement.

2. The ratchet wrench with a replaceable tool head as claimed in claim 1, wherein the annular groove is disposed under the ratchet teeth of the tool head, the engaging blocks of the detents corresponding to the annular groove and being disposed under the ratchet teeth of the detents.

3. The ratchet wrench with a replaceable tool head as claimed in claim 1, wherein an outer circumferential wall of the protruding post is provided with a first positioning member for the tool head to be positioned in the accommodation trough of the wrench main body.

4. The ratchet wrench with a replaceable tool head as claimed in claim 3, wherein the outer circumferential wall of the protruding post is transversely formed with a circular recess to accommodate the first positioning member, the first positioning member comprising a steel ball and a spring, the steel ball being disposed at a front end of the spring, the steel ball being biased by the spring.

5. The ratchet wrench with a replaceable tool head as claimed in claim 1, wherein a lever is provided on top of the switch block, a lower surface of the lever being formed with a recess, the wrench main body being provided with a second positioning member corresponding to the recess, the second positioning member being located at the center of the wrench main body.

6. The ratchet wrench with a replaceable tool head as claimed in claim 5, wherein a top of the wrench main body has a circular recess corresponding to the recess of the lever, the circular recess being adapted to accommodate the second positioning member, the second positioning member comprising a spring and a steel ball, the steel ball being disposed at an upper end of the spring, the steel ball being biased by the spring, the steel ball being engaged in the recess to position the lever.
